(19) United States
(12) Patent Application Publication
(10) Pub. No.: US 2015/0308400 A1
(43) Pub. Date: Oct. 29, 2015

(54) OPERATING PROCESS FOR A LEAN-BURN GAS ENGINE, AND LEAN-BURN GAS ENGINE

(71) Applicant: MTU Friedrichshafen GmbH, Friedrichshafen (DE)

(72) Inventors: Aron Toth, Friedrichshafen (DE); Wolfgang Fimml, Horbranz/Osterreich (AT); Alexander Bernhard, Meckenbeuren (DE)

(73) Assignee: MTU Friedrichshafen GmbH, Friedrichshafen (DE)

(21) Appl. No.: 14/695,816

(22) Filed: Apr. 24, 2015

(30) Foreign Application Priority Data
Apr. 25, 2014 (DE) 10 2014 005 986.3

(51) Int. Cl. F02P 5/145; F02D 41/00

(52) U.S. Cl. CPC F02P 5/145; F02D 41/008

(57) ABSTRACT

The invention relates to an operating process for a lean-burn gas engine having several cylinders, wherein the lean-burn gas engine includes a cylinder-individual gas metering arrangement and a cylinder-individual combustion process capture. The lean-burn gas engine is controlled by a control unit in such a manner that a combustion duration of the individual cylinders is regulated by a control unit, by way of a change of ignition timing of the individual cylinders. The control unit regulates the ignition timing of the individual cylinders in such a way that all cylinders are equalized in regard to their turnover point, so that a defined turnover point is achieved at a defined crank shaft angle.

### BACKGROUND OF THE INVENTION

1. Field of the Invention

The invention relates to an operating process for a lean-burn gas engine and to a lean-burn gas engine.

2. Description of the Related Art

Gas engines with leaner than stoichiometric gas-air-mixture react very sensitively to the smallest change in the mixture ratio. In real operation this has the effect that individual cylinders, because of stochastic or systematic differences that occur for example due to different casting batches or based on the position of the individual cylinder as a corner cylinder or a center cylinder, have an unfavorable influence over the engine operation. This can lead to a clearly increased peak pressure or also to a super-elevation of a cylinder-individual exhaust gas emission. As a result, the engine must be adapted to the worst cylinder, whereby this always signifies lower efficiency or heightened use of the total engine. Since the combustion process in such gas engines is very sensitive, even small changes in gas quality or respectively gas composition, or resulting irregularities in the engine control or gas metering lead to deviating emission. This must be counteracted by a pessimistic worst-case data input into the control unit. To date gas engines are basically calibrated for one gas and run reliably and cleanly only when using this gas.

It is known from U.S. Pat. No. 6,354,268 B1 that in order to optimize the efficiency of a self-ignition engine an adjustment of the maximum peak pressure or the peak pressure ratio at two selected points is to be performed. A gas engine is known from DE 197 54 353 C2 that is specifically in the embodiment of a dual-fuel engine. Here, an adjustment is made to the combustion chamber temperature. For this purpose, combustion chamber temperature sensors are required. WO 2012/097389 A2 discloses a method to operate an internal combustion engine, whereby cylinder equalization is performed via a cylinder-individual control or adjustment of the ignition point and/or the opening duration and/or the fuel supply pressure of the respective supply device for the fuel. A control variable is used for cylinder equalization adjustment, preferably the cylinder peak pressure or the cylinder medium pressure, or the cylinder-individual excess air number that is determined from the cylinder pressure progression.

What is needed in the art is a method for operation of a lean-burn gas engine, or respectively a lean-burn gas engine by way of which it is possible to equalize an unfavorable influence of stochastic or systematic differences between individual cylinders on the engine operation, and in particular to also keep the emission stable, regardless of the gas quality.

### SUMMARY OF THE INVENTION

The inventive operating process for a lean-burn gas engine having several cylinders, a cylinder-individual gas metering arrangement, a cylinder-individual combustion process capture and a control unit includes a number of steps. First, a combustion duration of the individual cylinders is regulated by the control unit, using a change of ignition timing of individual cylinders. The control unit regulates the ignition timing of the individual cylinders in such a way that all cylinders are equalized in regard to their turnover point, so that a defined turnover point is achieved at a defined crank shaft angle. Based on the equalization of the cylinders performed in regard to the turnover point, all cylinders are adjusted in their combustion processes and are therefore also adjusted in their emissions. The inventive operating process is independent of the gas quality. Therefore, the combustion processes and emissions are stable for the lean-burn gas engine, independent of the quality of the gas. The inventive operating process moreover makes it possible that lean-burn gas engines are tuned very closely to their design limits. Moreover, by controlling the combustion process or respectively the combustion duration, the form or respectively the character of the combustion rate is also fixed so that for all cylinders of the lean-burn engine, due to the similar temperatures in the cylinders, a similar detonation space results.

The operating process according to the current invention moreover provides that cylinder-individual pressure measurements for the cylinder-individual combustion progress capture are performed and that, on the basis of these pressure measurements a cylinder-individual pressure progression analysis is conducted. A pressure progression analysis of this type can be realized cost-effectively with standard components.

The operating process also defines the turnover point that is used for adjustment of the lean-burn gas engine between a 5% to 15% turnover point and in particular as a turnover point between approximately 8% and 12% and defines the crank shaft angle which is present in the defined turnover point as being between −5° and 0° and in particular at approximately −2°. Tests have shown that within such ranges of the defined turnover point and the defined crank shaft angle, good tuning of the lean burn engine is achieved.

The lean burn gas engine according to the invention includes several cylinders, a control unit for each cylinder, at least one pressure sensor for each cylinder and an igniter for each cylinder. The control unit includes an electronic circuit, whereby the electronic circuit calculates cylinder-individual pressure progressions from the measured signals of the pressure sensors and calculates cylinder-individual control signals for a cylinder-individual igniter to control the combustion duration. The control unit sends the control signals to the igniters of the individual cylinders. These cylinder-individual control signals predefine a cylinder-individual ignition point for the igniter. Based on the equalization of the cylinders in regard to the turnover point, all cylinders are equalized in their combustion progressions and are also equalized in their emissions. The lean burn gas engine according to the invention can thus be operated with low emissions independent of the gas quality. The lean burn gas engine moreover permits very close tuning to its design limits. Moreover, by controlling the combustion process or respectively the combustion duration, the form or respectively the character of the combustion rate is also fixed so that for all cylinders of the lean-burn gas engine due to the similar temperatures in the cylinders a similar detonation space results.

By equipping the lean burn gas engine with at least one gas metering device for each cylinder and at least one emission detection device, the operation of the lean burn gas engine can be influenced in a wider sense.

In the sense of the current invention a lean burn gas engine is understood to be an internal combustion engine which is also referred to as lean burn engine or lean mix engine which is operated with a lean or respectively leaner than stoichiometric gas-air-mixture. By “lean” it is understood that there is more air or respectively combustion air available than is required for the stoichiometric combustion of the fuel gas in the cylinder. This means that lamda is >1.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawing, wherein:

FIG. 1 shows a schematic illustration of a lean burn gas engine

Corresponding reference characters indicate corresponding parts throughout the several views. The exemplification set out herein illustrates one embodiment of the invention, in one form, and such exemplification is not to be construed as limiting the scope of the invention in any manner.

### DETAILED DESCRIPTION OF THE INVENTION

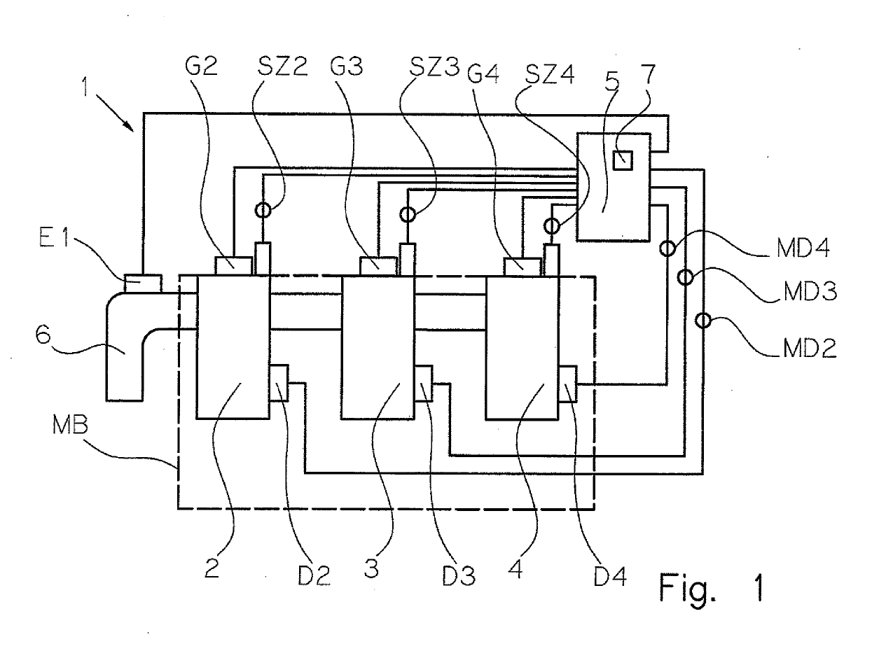

FIG. 1 schematically illustrates a lean burn gas engine 1. Lean burn gas engine 1 includes an engine block MB having several cylinders 2, 3, and 4, one control unit 5 for each cylinder 2, 3, and 4, at least one pressure sensor D2, D3, and D4 for each cylinder 2, 3, and 4, and an ignition unit Z2, Z3, and Z4 for each cylinder 2, 3, and 4. Lean burn gas engine 1 moreover includes at least one gas metering device G2, G3, and G4 for each cylinder 2, 3, and 4 and at least one emission detection device E1. If provided emission detection device El hereby captures emission values such as for example NOx-emission values, if present, in an exhaust system 6 of lean burn engine 1. Control unit 5 includes an electronic system 7. Electronic system 7 calculates cylinder-individual pressure progressions from measured signals MD2, MD3, and MD4 of pressure sensors D2, D3, and D4 and therefrom calculates cylinder-individual control signals SZ2, SZ3, and SZ4 for the cylinder-individual ignition units Z2, Z3, and Z4 for cylinder-individual adaptations of the combustion duration or respectively of the combustion progression and issues these to ignition devices Z2, Z3, and Z4 of individual cylinders 2, 3, and 4. Based on the cylinder-individual control signals SZ2, SZ3, and SZ4 for ignition devices Z2, Z3, and Z4, a cylinder-individual ignition timing point is determined, depending on an individual pressure progression of individual cylinder 2, 3, and 4, so that the combustion progression or respectively combustion durations of individual cylinders 2, 3, and 4 can be equalized. The cylinder-individual ignition timing points are hereby selected such that each cylinder achieves a predefined turnover point that is the same for all cylinders at a predefined crank angle position.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An operating process for a lean-burn gas engine having several cylinders, comprising the steps of:
providing a cylinder-individual gas metering arrangement;
capturing a cylinder-individual combustion process;
controlling the lean-burn gas engine using at least one control unit;
regulating a combustion duration of individual cylinders using said at least one control unit, by way of a change of an ignition timing of said individual cylinders; and
regulating said ignition timing of said individual cylinders using said at least one control unit in such a way that all said individual cylinders are equalized in regard to a turnover point of each cylinder, so that a defined turnover point for each said cylinder is achieved at a defined crank shaft angle.

2. The operating process for a lean-burn gas engine having several cylinders of claim 1, further comprising the steps of:
performing cylinder-individual pressure measurements for said capture of said cylinder-individual combustion process; and
conducting on the basis of said cylinder-individual pressure measurements a cylinder-individual pressure progression analysis using said at least one control unit.

3. The operating process for a lean-burn gas engine having several cylinders of claim 1, wherein:
said turnover point is defined as a turnover point between a 5% to 15% turnover point and said crank shaft angle which is present in the defined turnover point is defined as a crank shaft angle being between −5° and 0°.

4. The operating process for a lean-burn gas engine having several cylinders of claim 3, wherein:
said turnover point is defined as a turnover point between a 8% and 12% turnover point and said crank shaft angle which is present in the defined turnover point is defined as a crank shaft angle being of approximately −2°.

5. The operating process for a lean-burn gas engine having several cylinders of claim 1, further comprising the steps of:
providing one control unit for each cylinder;
providing at least one pressure sensor for each cylinder; and
providing at least one ignition unit for each cylinder.

6. The operating process for a lean-burn gas engine having several cylinders of claim 1, wherein:
said at least one control unit comprises an electronic system;
said electronic system calculating at least one cylinder-individual pressure progression from measured signals of at least one pressure sensor and therefrom calculating at least one cylinder-individual control signal to adapt a combustion duration for at least one cylinder-individual ignition device, said electronic system issuing said at least one cylinder-individual control signal to said at least one cylinder-individual ignition device; and
said at least one cylinder-individual control signal for said at least one cylinder-individual ignition device determining a cylinder-individual ignition timing point.

7. The operating process for a lean-burn gas engine according to claim 6, further comprising the steps of:
providing at least one gas metering device for each cylinder; and
providing at least one emission detection device.
